(19) United States
(12) Patent Application Publication
(10) Pub. No.: US 2015/0293603 A1
(43) Pub. Date: Oct. 15, 2015

(54) SINGLE-HANDED COMPUTER KEYBOARD

(71) Applicants: Dan Liang, Pleasanton, CA (US); Jeffrey Zhang, Pleasanton, CA (US); Benjamin Zhang, Pleasanton, CA (US); Chun Zhao, Pleasanton, CA (US)

(72) Inventors: Dan Liang, Pleasanton, CA (US); Jeffrey Zhang, Pleasanton, CA (US); Benjamin Zhang, Pleasanton, CA (US); Chun Zhao, Pleasanton, CA (US)

(21) Appl. No.: 14/249,376

(22) Filed: Apr. 10, 2014

(51) Int. Cl. G06F 3/02

(52) U.S. Cl. CPC G06F 3/0219

(57) ABSTRACT

A single hand keyboard is disclosed. The single hand keyboard comprises on a left side a plurality of keys representing one half of a typing keyboard wherein each key is a pair of characters representing the normal and function keys of a full keyboard layout, one of the characters being normally associated with the key in a typing keyboard and the other character being associated with an opposite key of the other half of the typing keyboard by overlapping and combining the characters for each key. One or more toggle keys are provided for switching between the pair of characters indicated on each key of the keyboard wherein said switching is indicated by one or more LEDs. The right side of the single hand keyboard comprises the standard grouping of special, lock and direction keys including a standard numeric keypad.

### TECHNICAL FIELD OF THE INVENTION

This invention relates to keyboards, and more particularly to a keyboard layout that is designed for single-handed operation.

### DESCRIPTION OF RELATED ART

As a new generation of portable computers get smaller, it is desirable to have smaller than standard-sized keyboards. Currently, this need is typically met by the “miniaturized keyboard” in which the size of standard layout keys is reduced to achieve the smaller sizes desired. This miniaturization is typically based off of using a standard QWERTY keyboard, so named for the first six keys on the top row. This past approach has had limited efficiency and a minimum level of success at miniaturization, since the size of a user's hands and fingers remains constant. Some of the results when using these miniaturized keyboards is that the user inadvertently strikes multiple keys or the users are forced to resort to slowly typing each key with their forefingers in a “hunt and peck” style.

A preferred approach to the above problem is the use of one-handed keyboards. These prior art keyboards are smaller, since they require fewer keys than the minimum 72-key standard computer keyboard layout. By requiring fewer keys, the benefit of one-handed keyboards is that they are designed to utilize full-sized keys, but require fewer keys by employing key mapping techniques.

It should be noted that one-handed or single-handed keyboards are also useful in any application where the use of one-hand is preferred. Examples of such uses include CAD/CAM operators, video garners and typists all who prefer to keep one hand on a “mouse” type input device while keeping their second hand on their keyboard. Additionally, inventory recording devices allow the user to handle items with one hand while inputting data with the other; and for users with disabilities that allow the functional use of only one of their hands.

Also, the disadvantage of a traditional two-handed QWERTY keyboard design is that it is quite large thus requiring both hands to be used at all times. Therefore, there is a need for a new single handed keyboard layout that is easy to learn and frees up one of the user's hands for performing other tasks.

### SUMMARY OF THE INVENTION

A single hand keyboard is disclosed. The single hand keyboard comprises on a left side a plurality of keys representing one half of a typing keyboard wherein each key is a pair of characters representing the normal and function keys of a full keyboard layout, one of the characters being normally associated with the key in a typing keyboard and the other character being associated with an opposite key of the other half of the typing keyboard by overlapping and combining the characters for each key. One or more toggle keys are provided for switching between the pair of characters indicated on each key of the keyboard wherein said switching is indicated by one or more LEDs. The right side of the single hand keyboard comprises the standard grouping of special, lock and direction keys including a standard numeric keypad.

### BRIEF DESCRIPTION OF THE DRAWINGS

FIG. 1 shows a drawing of a prior art QWERTY keyboard in a split configuration illustrating a prior art keyboard mapping technique;

FIG. 2 shows a drawing of a prior art QWERTY one handed computer keyboard;

FIG. 3 shows a drawing of a prior art QWERTY keyboard in a split configuration illustrating a keyboard mapping technique in accordance with the present invention;

FIG. 4 shows a drawing of a single hand computer keyboard according to the present invention;

FIG. 5 shows a drawing of another embodiment of the single hand computer keyboard according to the present invention;

FIG. 6 shows a drawing of another embodiment of the single hand computer keyboard according to the present invention; and

FIG. 7 shows a drawing of an embodiment for using the single hand computer keyboard according to the present invention.

### DETAILED DESCRIPTION OF THE EMBODIMENTS

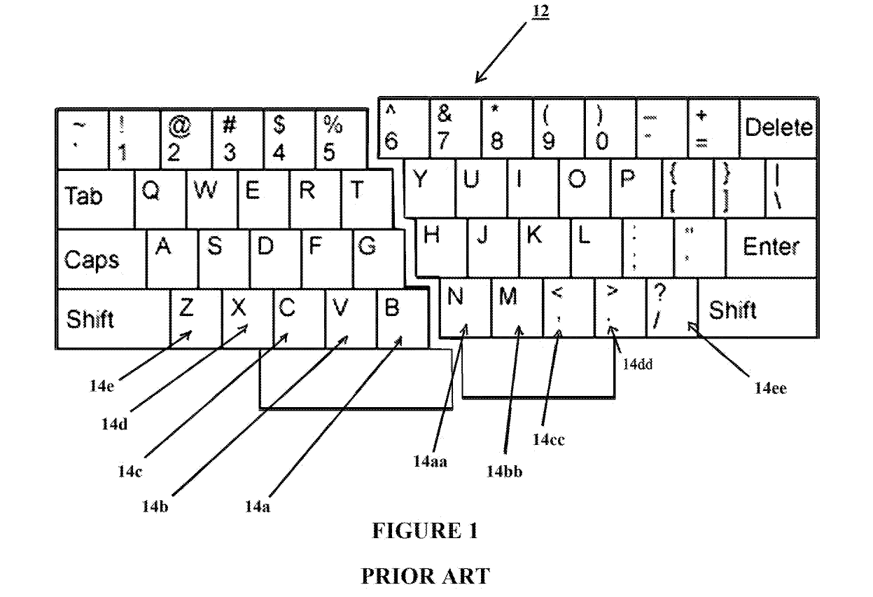

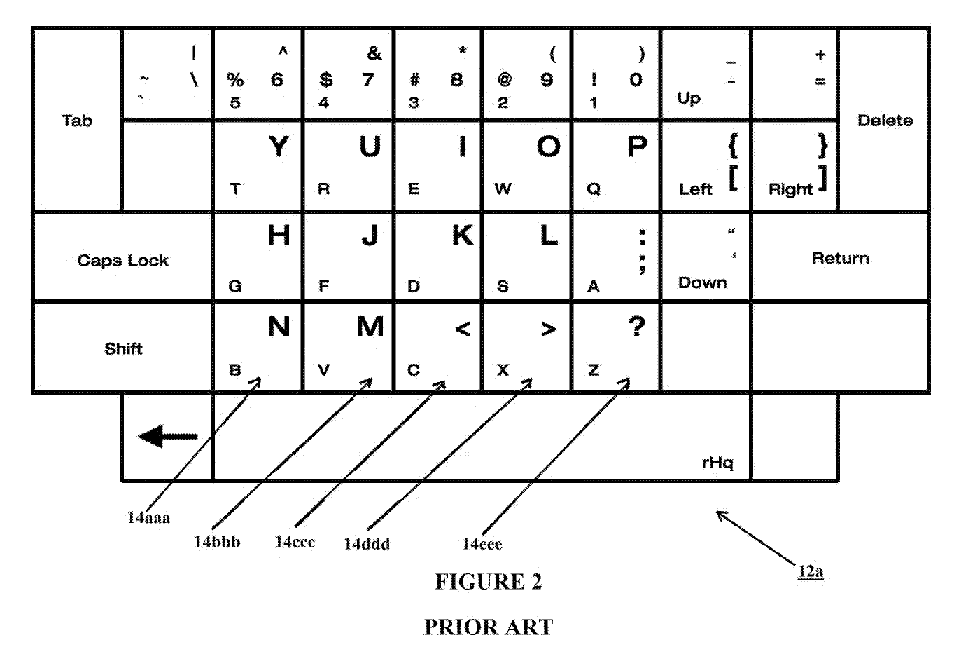

Referring now to FIG. 1 there is shown a drawing of a prior art QWERTY keyboard 12 as shown and described in U.S. Pat. No. 5,288,158 issued to Edgar Matias on Feb. 22, 1994 (hereinafter referred to as the “Matias reference”). The prior art QWERTY keyboard 12 is shown in the Matias reference in a split configuration and will be discussed here for purposes of explaining and illustrating one type of prior art keyboard mapping technique. Turning once again to FIG. 1, as shown in the Matias reference, the prior art keyboard 12 splits roughly in half at the point where the left and right hand keys meet. The Matias reference maps two (2) keys onto one key by placing the left key character and corresponding mirrored right key character onto a single key, thus reducing the board size down. More specifically, the keys 14a through 14e on the left side and keys 14aa through 14ee are mirrored keys and when combined produce keys having character pairs 14aaa through 14eee as shown in the prior art Matias reference keyboard 12a shown in FIG. 2. Thus, each left hand finger strikes keys on the left hand side of the keyboard which are symmetrically opposite and mirrored to the keys struck by the corresponding finger of the right hand on the right side of the keyboard.

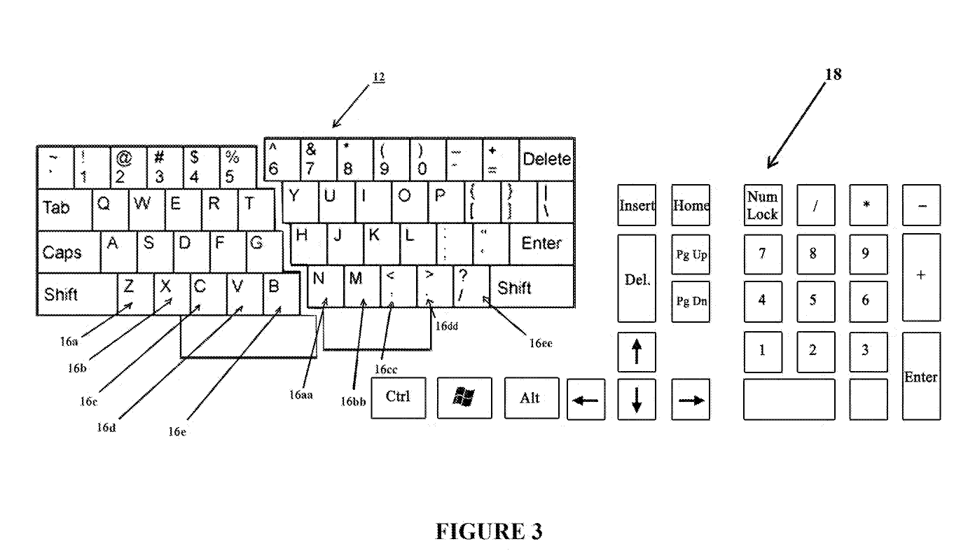

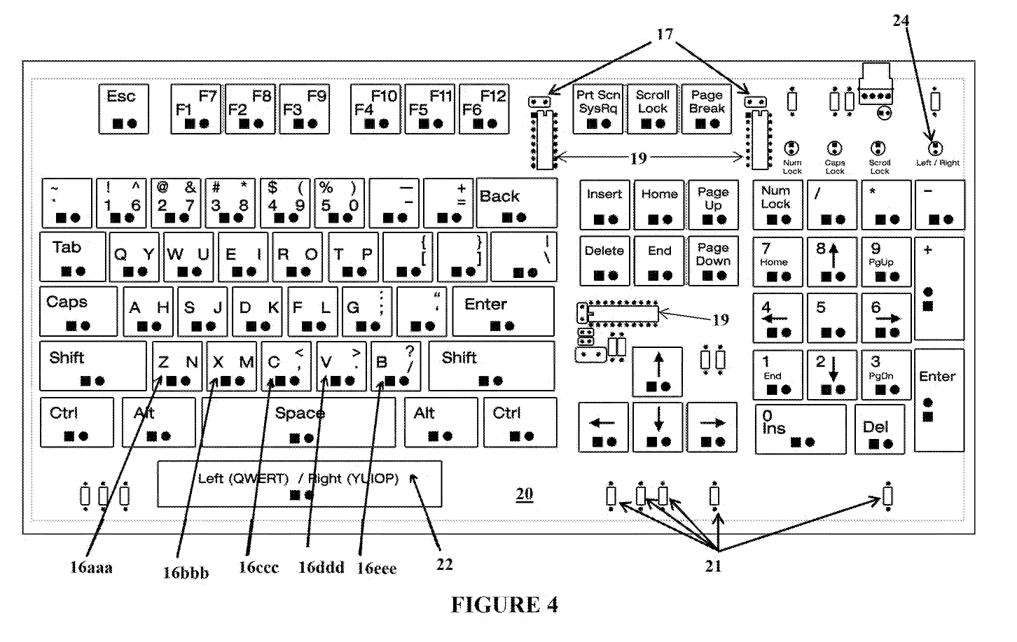

According to the present invention and referring to FIG. 3 and using the split Matias reference keyboard 12, Applicant's keyboard maps two (2) keys onto one key by overlapping the left key character and corresponding right key character onto a single key, thus reducing the board size down. More specifically, the keys 16a through 16e on the left side and keys 16aa through 16ee are overlapped keys and when combined produce keys having character pairs 16aaa through 16eee as shown in FIG. 4. By assigning two letters or characters to each key 16, and utilizing modifier keys 22 to switch between each such letter or character and shift between upper and lower case, a single-handed half-keyboard 20 may be provided in which letters of the missing half of the keyboard are arranged to correspond exactly to their original hand pattern except on the other hand. By maintaining the traditional arrangement or layout of keys 16 of an entire QWERTY keyboard superimposed onto one half, it is believed that a keyboard computer user will require very little time to gain proficiency on a such a single-handed keyboard as opposed to the mirrored mapping technique as taught by Matias.

Turning once again to FIG. 4, when the user strikes the left/right spacer key/bar an LED indicator 24 lights up indicating which character pair is being typed. This is especially useful if the user has to leave their keyboard and come back at a later time and not lose track if they are in left character or right character key mode. Turning once again to FIG. 3, the right side of the single handed keyboard further defines the standard grouping of special, lock and direction keys including a standard numeric keypad 18. Turning now to FIG. 4, located on the keyboard are filter caps 17, IC chips 19 and a plurality of pull-down resistors 21 needed for board functionality.

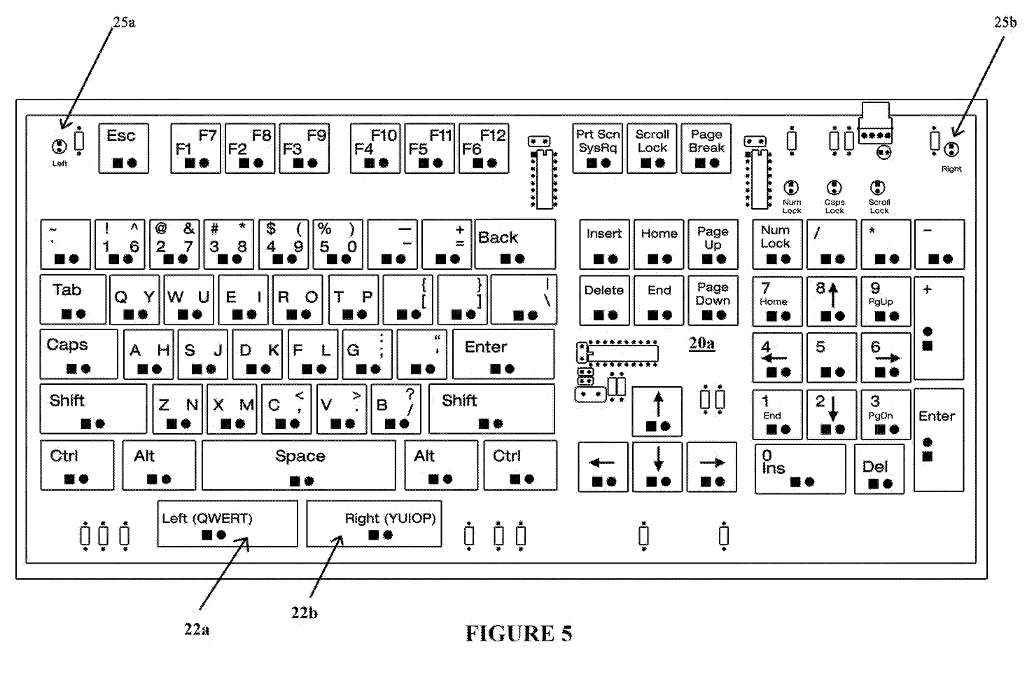

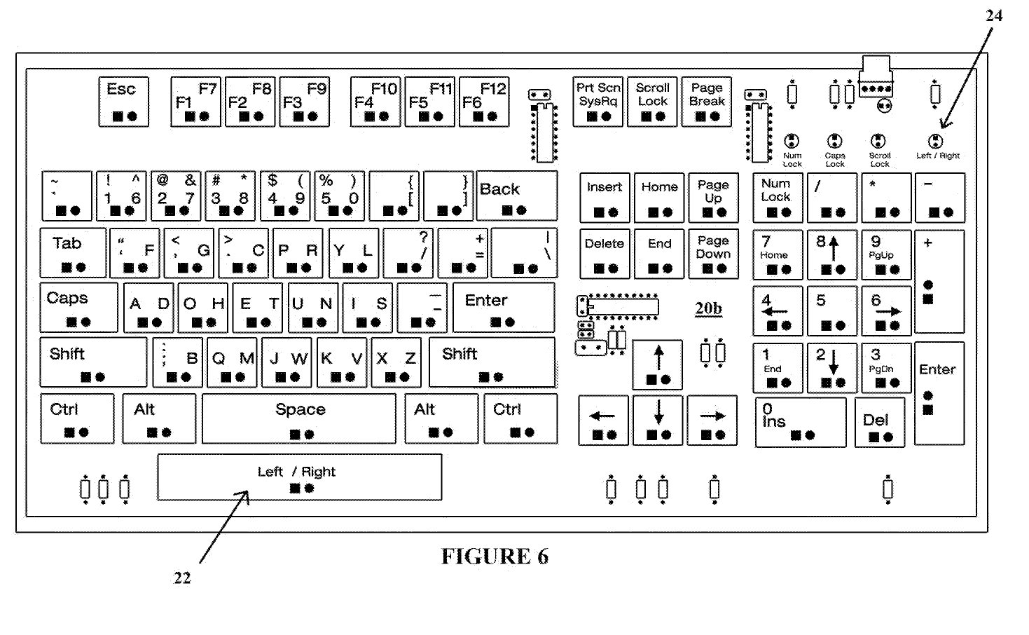

Referring now to FIGS. 4 and 5, there are shown two additional preferred embodiments of the single-handed keyboard 20a and 20b respectively, wherein FIG. 6 illustrates a DVORAK keyboard similar to keyboard layout 20 and operates the same as keyboard 20 using a single toggle key 22 and LED indicator light 24 as discussed above. The keyboard 20a uses two separate keys 22a and 22b (as shown in FIG. 5) for choosing left or right characters on the keys which in turn toggle corresponding LED lights 25a and 25b respectively, as described above. It should be understood that keyboard 20, 20a or 20b may be modelled by overlapping both QWERTY or DVORAK layouts, and adapted for users of computer keyboards who wish to type with either their right or left hand only or use both hands by use of left and right-handed keys 22a and 22b as shown in FIG. 5. Additionally, the subject invention is envisioned to use keyboard layouts in all the different international foreign languages in their respective foreign letter language. An example of a single handed keyboard in Chinese for instance would use for example, Chinese spelling letters (Pinyin) which are arranged in same way as the QWERTY keyboard (not shown). The same type arrangement may be applied to other languages which uses the same or similar typing method employing the key mapping technique of overlapping corresponding characters as shown and described in Applicant's invention.

The single-handed keyboard of the present invention may be manufactured according to known industrial techniques, and performs the utilitarian function of enabling input of alpha-numeric information using only one hand. It should also be noted that on the left side of the single-handed keyboard the tab, caps, shift, ctrl and alt key are shown with left/right functionality but may be left as standard keys as used on conventional two-handed keyboards.

In summary, the single-handed keyboard of the present invention benefits from numerous advantages over a typing two-handed full-QWERTY/DVORAK layout design. For instance, the keyboard is more compact, being over one third smaller than a full-sized two-handed keyboard. This allows for the design of smaller computers and word processors without sacrificing the ability to touch-type. The design of the present invention requires only one hand for operation. Thus, the other hand of the user is left free for hand writing, control of a mouse/joystick, etc. The physically handicapped may only have the use of one hand but are still are able to touch-type with the keyboard of the present invention. Also, a keyboard user may type the keyboard by single hand alternating to let their other hand rest while not typing. The keyboard also allows the keyboard user to first learn how to type by the usual or regular (two hands) typing experience and therefore has less of a learning curve to overcome. This will also give the keyboard user the opportunity of having the same or similar typing experience of using both type of keyboards, i.e. single hand or a two handed keyboard.

Furthermore, the single-handed keyboard 20 of the present invention may reduce the keyboard size and weight making the keyboard easier to carry or transport. Additionally it is envisioned that the same type of keyboard layout may be implemented on a personal tablet computer (not shown), for example an IPAD or Nexus. This may save more keyboard space for a fixed size display screen which may result in an increase in the APP viewing area. The possible applications of using a single handed keyboard include the following: the keyboard user may type on the keyboard with one hand while simultaneously using a mouse or joystick with their other hand resulting in saving time from having to move a hand between a keyboard and pointer device. When a touchpad is attached to the keyboard 20, this may also reduce or avoid unnecessary finger touching on the touchpad since only a single hand is on the keyboard.

Moreover, the single-handed keyboard of the present invention is horizontally symmetrical. Therefore, there need not be any physical difference between a left and a right hand keyboard, thus allowing concurrent production of left and right hand keyboards without the increase in production costs that is characteristic of prior art two-handed keyboards having angularly offset keys. This also allows for remapping of the keyboard to form a numeric keypad (e.g. telephone key pad). In other words, the problem of prior art two-handed keyboards is not present with the single-handed keyboard of the present invention, since the keyboard user's arm does not protrude at an angle. Instead, the keyboard user's arm extends perpendicularly of the keyboard. Therefore, the keys need not be slanted. They may be arranged in a more comfortable and more convenient orthogonal grid pattern.

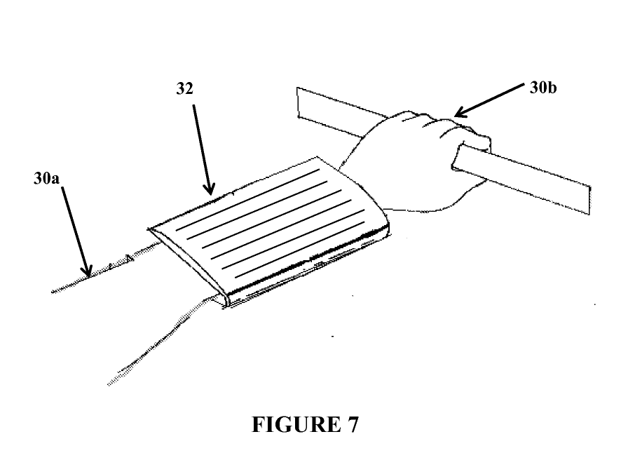

Similar variations may be made to the single-handed keyboard of the present design, without departing from the principles set forth. As shown in FIG. 7, in another preferred embodiment it is possible that a single hand keyboard with straps 32 may be attached to the left (or right) lower arm 30a close to the user's hand 30b wherein the user types the keyboard with their other hand (not shown). Additionally, by combining the keyboard of the present invention with a “Google Glass” type of video device (not shown) allows a keyboard user greater flexibility to carry around a personal computer or similar tablet type device such as for example an iPad or kindle or iwatch to name a few. By attaching these types of devices on one lower arm and by attaching the single hand keyboard to the other lower arm, a keyboard user may watch the tablet type device while simultaneously typing on a single hand keyboard. One or more modifier keys may be placed in any location (and in whatever shape) that is convenient. Additionally, the keyboard may be attached to a user's upper arm portion while at the same time attaching a tablet like device to the user's lower arm portion (or hold by hand), the user may now type on the keyboard while simultaneously watching the tablet like device.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Although particular embodiments of the invention have been shown and described in full here, there is no intention to thereby limit the invention to the details of such embodiments. On the contrary, the intention is to cover all modifications, alternatives, embodiments, usages and equivalents of the subject invention as fall within the spirit and scope of the invention, specification, and the appended claims.

1. A single hand computer keyboard comprising:
a plurality of keys representing one half or more the number of keys in the typing keyboard;
assigning a pair of different characters to each key of said plurality of keys, one of said characters being normally associated with the sequence of characters on the one half of the typing two-handed keyboard and the other of said characters being associated with the sequence of characters on the other half of the typing two-handed keyboard in an overlapping fashion;
controlling said assigned pair of characters to each key by use of one or more toggle keys for switching between the sequences of different characters on said single-handed keyboard thereby providing single-handed operation of said keyboard which may use touch-typing techniques normally used with typing two-handed keyboards.

2. The single hand computer keyboard, as defined in claim 1, wherein said keyboard is a QWERTY keyboard having overlapping and corresponding characters keys and further defining standard grouping of special, lock and direction keys including a standard numeric keypad.

3. The single handed computer keyboard, as defined in claim 1, wherein the typing two-handed typing keyboard is a DVORAK having overlapping and corresponding characters keys and further defining standard grouping of special, lock and direction keys including a standard numeric keypad.

4. The single handed computer keyboard, as defined in claim 1, wherein additional keys are provided for allowing either right or left handed typing or using both hands.

5. The single handed computer keyboard, as defined in claim 1, wherein said plurality of keys comprises an orthogonal grid arrangement.

6. The single hand computer keyboard, as defined in claim 2, in which said pair of different characters on each key of said plurality of keys is arranged in a right-handed QWERTY configuration wherein said one of said characters on each of said keys is arranged consistent with the sequence of characters on the right-hand half of the typing two-handed QWERTY keyboard and the other of said characters is arranged in as an overlapped mirror image of the sequence of characters on the left-hand half of the typing two-handed QWERTY keyboard.

7. The single hand computer keyboard, as defined in claim 2, in which said pair of different characters on each key of said plurality of keys is arranged in a left-handed QWERTY configuration wherein said one of said characters on each of said keys is arranged consistent with the sequence of characters on the left-hand half of the typing two-handed QWERTY keyboard and the other of said characters is arranged in an overlapping mirror image of the sequence of characters on the right-hand half of the typing two-handed QWERTY keyboard.

8. The single hand computer keyboard, as set forth in claim 3, in which said pair of different characters on each key of said plurality of keys is arranged in a right-handed DVORAK configuration wherein said one of said characters on each of said keys is arranged consistent with the sequence of characters on the right-hand half of the typing two-handed DVORAK keyboard and the other of said characters is arranged in an overlapping mirror image of the sequence of characters on the left-hand half of the typing two-handed DVORAK keyboard.

9. The single hand computer keyboard according to claim 1, wherein said keyboard is an IPAD display.

10. The single hand computer keyboard according to claim 1, wherein said keyboard is used as a smartphone display.

11. The single hand computer keyboard according to in claim 3, in which said pair of different characters on each key of said plurality of keys is arranged in a left-handed PINYIN configuration which corresponds to said QWERTY layout wherein said one of said characters on each of said keys is arranged consistent with the sequence of characters on the left-hand half of the typing two-handed PINYIN keyboard and the other of said characters is arranged in an overlapping mirror image of the sequence of characters on the right-hand half of the typing two-handed PINYIN keyboard.

12. The single hand computer keyboard according to claim 1, wherein said keyboard is used as a tablet display.

13. The single hand computer keyboard according claim 1, wherein pressing said one or more toggle switches lights one or more corresponding LEDS located on said keyboard.

14. The single hand computer keyboard according to in claim 2, in which said pair of different characters on each key of said plurality of keys is arranged in a left-handed foreign letter language configuration wherein said one of said characters on each of said keys is arranged consistent with the sequence of characters on the left-hand half of the typing two-handed foreign letter language keyboard and the other of said characters is arranged in an overlapping mirror image of the sequence of characters on the right-hand half of the typing two-handed foreign letter language keyboard.

15. The single hand computer keyboard according to claim 3, in which said pair of different characters on each key of said plurality of keys is arranged in a right-handed foreign letter language configuration wherein said one of said characters on each of said keys is arranged consistent with the sequence of characters on the right-hand half of the typing two-handed foreign letter language keyboard and the other of said characters is arranged in an overlapping mirror image of the sequence of characters on the left-hand half of the typing two-handed DVORAK keyboard.

16. A single hand keyboard comprising:
a plurality of keys representing one half of a standard typing keyboard wherein each key is a pair of characters representing normal and function keys of a full keyboard layout, one of said characters being normally associated with a key in a typing keyboard and the other character being associated with an opposite key of the other half of the typing keyboard by overlapping and combining the characters for each key;
one or more toggle keys for switching between characters indicated on each key of the keyboard wherein said switching is indicated by one or more LEDs

17. The single hand keyboard of claim 16 further comprising the standard grouping of special, lock and direction keys including a standard numeric keypad.
